(19) United States
(12) Patent Application Publication
(10) Pub. No.: US 2022/0398247 A1
(43) Pub. Date: Dec. 15, 2022

(54) NATURAL LANGUAGE TRIGGERING FOR SEARCH ANSWER EXTENSIBILITY

(71) Applicant: Microsoft Technology Licensing, LLC, Redmond, WA (US)

(72) Inventors: Ming WU, Kirkland, WA (US); Zhiguo YU, Redmond, WA (US); Viktoriya TARANOV, Kirkland, WA (US)

(73) Assignee: Microsoft Technology Licensing, LLC, Redmond, WA (US)

(21) Appl. No.: 17/348,591

(22) Filed: Jun. 15, 2021

(51) Int. Cl. G06F 16/2452; G06F 16/242; G06F 16/2457; G06F 16/248

(52) U.S. Cl. CPC G06F 16/24522; G06F 16/2448; G06F 16/24573; G06F 16/248

(57) ABSTRACT

Embodiments provide search answer extensibility by using either one or more primary applications that is executing or residing on, or is accessible to, a first computing device that receives a natural language (NL) query and/or one or more assigned applications that is executing or residing on the first computing device or on a different second computing device to process the NL query and provide a response to the NL query.

### BACKGROUND

Conventional search applications and search functionality can typically only retrieve data that is accessible to the search application. In some instances, data that is stored on a storage device that is not accessible by the search application may be relevant to a query. For example, in an enterprise system, data in one department of the enterprise may not be accessible by an enterprise search application because the data is confidential, privileged, or protected based on a compliance policy. In such situations, the department may use a custom search application that is specific to the types of data used by that department. Thus, different search applications can be used by different departments within the enterprise. A user of a particular search application may be required to know the types of data available to the search application and to use a strict query format when submitting a query, limiting the utility of the search application.

It is with respect to these and other general considerations that embodiments have been described. Also, although relatively specific problems have been discussed, it should be understood that the embodiments should not be limited to solving the specific problems identified in the background.

### SUMMARY

Embodiments disclosed herein provide search answer extensibility by selectively triggering the use of one or more assigned applications that are executing or residing on one or more computing devices to process a natural language (NL) query. In a non-limiting embodiment, a first or “primary application” is the application that initially receives an NL query from a user. In a non-limiting embodiment, an “assigned application” is a second application other than the first application that process the NL query to produce a response to the NL query. The primary and the assigned applications can be located on the same computing device or on different computing devices. In some instances, the primary application receives the NL query from the user and the primary application processes the NL query to produce a response to the NL query. In other situations, the NL query is transmitted (or caused to be transmitted) to an assigned application which processes the NL query to provide a response to the NL query. The NL query is provided to the assigned application for processing, for example, because the second application is able to access data that is not accessible to the primary application or computing device.

Additionally, the phrases “natural language query” and “NL query” are not limited to a natural language sentence (e.g., a set of words that is complete in itself, typically containing a subject and predicate). Instead, the phrases “natural language query” and “NL query” should be interpreted broadly to include a natural language query, a pseudo-natural language query, one or more keywords, and/or or acronyms. Additionally, a query is not limited to a question, but includes a request for information or a statement that will return data, as well as non-textual content such as an image.

In one aspect, a method includes receiving an NL query. Based on a similarity between the NL query and one or more predefined queries that are each associated with an assigned application, a determination is made that the NL query is to be processed by the assigned application. The NL query is transmitted, or caused to be transmitted, to the assigned application to enable the assigned application to process the NL query. A response to the NL query is received and is provided, or caused to be provided, to an output device.

In another aspect, a system includes a processing device and a storage device operably connected to the processing device. The storage device stores instructions, that when executed by the processing device, cause operations to be performed. The operations include receiving an NL query, determining a first similarity score between the NL query and a first predefined query that is associated with a first assigned application, and determining a second similarity score between the NL query and a second assigned application. When a value of the second similarity score is higher than a value of the first similarity score, the NL query is transmitted to the second assigned application to enable the second assigned application to process the NL query. A first response to the NL query is received and provided to an output device. When the value of the first similarity score is higher than the value of the second similarity score, the NL query is transmitted to the first assigned application to enable the first assigned application to process the NL query. A second response to the NL query is received and provided to the output device.

In yet another aspect, a method includes a primary application receiving an NL query and determining a first similarity score between the NL query and a predefined query, where the predefined query is associated with an assigned application. A second similarity score between the NL query and a data domain is determined, where the data domain is associated with data that is accessible by the primary application. A determination is made that a value of the first similarity score is higher than a value of the second similarity score. Based on the determination, a determination is made that the NL query is to be processed by the assigned application. The NL query is transmitted, or caused to be transmitted, to the assigned application to enable the assigned application to process the NL query. A response to the NL query is received and provided to an output device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 depicts an example system in accordance with some embodiments;

FIG. 2 illustrates a flowchart of a first example method of managing an NL query in accordance with some embodiments;

FIGS. 3A-3B illustrate a flowchart of a second example method of managing an NL query in accordance with some embodiments;

FIG. 4 illustrates an example system for triggering an assigned application to extend search functionality in accordance with some embodiments;

FIG. 5 illustrates an example query in accordance with some embodiments;

FIG. 6 illustrates example implementations of the method shown in FIGS. 3A-3B in accordance with some embodiments;

FIG. 7 illustrates an example graphical user interface for providing a response to an NL query in accordance with some embodiments;

FIG. 8 illustrates an example system that enables interaction with an assigned application in accordance with some embodiments;

FIG. 9 illustrates a flowchart of a method of enabling a user to provide information associated with an assigned application in accordance with some embodiments;

FIG. 10 illustrates an example graphical user interface for enabling a user to provide information associated with an assigned application in accordance with some embodiments;

FIG. 11 illustrates a flowchart of an example method of enabling a user to provide information for an assigned application in accordance with some embodiments;

FIG. 12 illustrates a first example graphical user interface for enabling a user to provide information associated with an assigned application in accordance with some embodiments;

FIG. 13 illustrates a second example graphical user interface for enabling a user to provide information associated with an assigned application in accordance with some embodiments;

FIG. 14 illustrates a block diagram depicting example physical components of a computing device with which aspects of the disclosure may be practiced;

FIGS. 15A-15B illustrate block diagrams illustrating a mobile computing device with which aspects of the present disclosure may be practiced; and

FIG. 16 illustrates a block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Disclosed herein are embodiments that provide search answer extensibility by using a primary application that is located on, or is accessible to, a first computing device that receives a natural language (NL) query and/or one or more assigned applications that is executing or residing on the first computing device or on a different second computing device to process the NL query and provide a response or responses to the NL query. To determine whether the NL query triggers the use of the assigned application(s) to process the NL query, an unsupervised deep similarity-based model can be used to compute the similarity between an NL query and one or more predefined queries. When the NL query is to be processed by at least one assigned application, the NL query is passed to each assigned application and a response to the NL query is produced by each assigned application. Additionally or alternatively, the NL query is processed by the primary application to produce a response to the NL query. In one embodiment, the primary application processes the NL query using a supervised model to produce a response to the query.

In one embodiment, the words in the NL query are compared with pre-stored predefined queries that are associated with each assigned application to determine how similar the NL query is to one or more pre-defined queries (e.g., how much semantic overlap). This can be used to identify the most relevant application or applications to process the NL query. The most relevant application can be the primary application, one or more assigned applications, or both the primary and one or more assigned application. The NL query is compared with the pre-stored queries to determine whether the NL query triggers the use of one or more assigned applications to process the NL query. If so, the NL query is passed to each of the identified one or more assigned applications and a response to the NL query is produced by the assigned application. The response(s) is provided to primary application that received the NL query. The response(s) can be presented to a user by an output device, such as a display or a speaker.

The triggering application is a language understanding or machine learning application that is adaptable and scalable over one or more assigned applications. The triggering application enables new assigned applications, new or revised predefined queries, and other information to be immediately available for use by the triggering application. Over time, the triggering application learns and becomes more efficient and effective at determining whether to use an assigned application to process an NL query, in selecting which assigned application is to be used to process an NL query, and in determining which predefined queries (or which words in the predefined queries) trigger the use of the assigned application.

Technical advantages to the example embodiments include the ability to discover and use applications that previously were not utilized and to provide users with an improved user experience. Additional data can be reviewed to determine if the data is responsive to a NL query. New or revised applications and/or predefined queries are available to a system as soon as the applications and predefined queries are submitted, which enables the responses to the NL queries to reflect the changes more quickly. Additionally, an unsupervised deep similarity-based model can be used to determine whether a NL query triggers the use of one or more assigned applications to process the NL query, which means the system does not need to train the model prior to use. The updates to the model can be performed asynchronously with respect to the addition of an assigned application and/or predefined queries.

As noted earlier, the phrases “natural language query” and “NL query” are to be interpreted broadly to include a natural language query, a pseudo-natural language query, one or more keywords, or acronyms. Additionally, a query is not limited to a question, but includes a request for information or a statement that will return data.

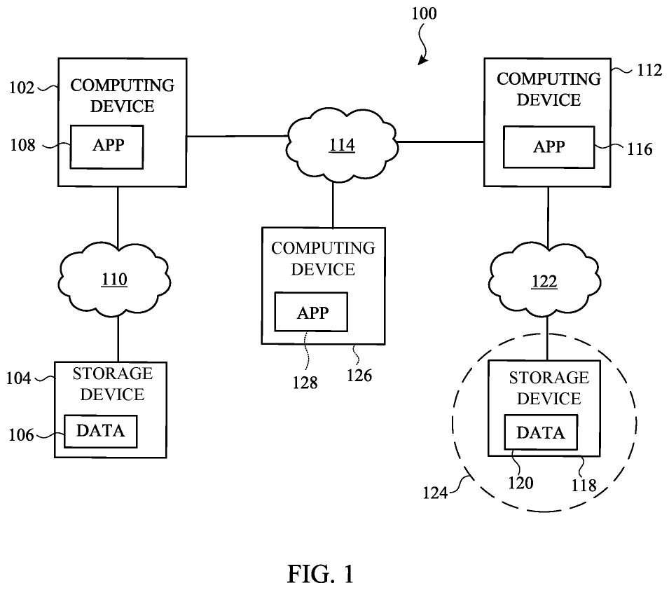

FIG. 1 depicts an example system in accordance with some embodiments. The system 100 includes a computing device 102 operably connected to one or more storage devices (collectively referred to as storage device 104). The storage device 104 stores data 106 that is created, accessed, used and/or stored by one or more applications (collectively referred to as application 108) residing or executing on the computing device 102. In some embodiments, the computing device 102 accesses the storage device 104 through one or more networks (collectively referred to as network 110).

Application 108 is stored in a storage device (e.g., a memory) in the computing device 102. The application 108 can include a search application, a dialogue system, a virtual assistant, or one or more other applications that includes search functionality. In some embodiments, the search functionality is provided by the virtual assistant or the dialogue system. The term “application” is to be construed broadly to include bots, virtual assistants, dialogue systems, and software applications that are each designed to perform one or more specific tasks. Example applications include, but are not limited to, a word processing application, a spreadsheet application, an electronic mail application, a messaging application, a collaboration application, a presentation application, a virtual assistant, a dialogue system, and an internet browser application.

The computing device 102 is operably connected to the computing device 112 through one or more networks (collective referred to as network 114). One or more applications (collectively referred to as application 116) is stored in a storage device (e.g., a memory) in the computing device 112. The computing device 112 is operably connected to a storage device 118 and is configured to access the storage device 118 and the data 120 stored on the storage device 118. In some embodiments, the computing device 112 is operably connected to the storage device 118 through one or more networks (collectively referred to as network 122).

The computing device 102 can receive a NL query for a search operation, which is processed by the application 108. During processing, the application 108 can access the data 106 to provide a response to the NL query. Processing the NL query includes the application 108 performing a search operation using the NL query and/or providing the NL query to a search application to perform a search based on the NL query (e.g., a search application on the computing device 102).

In some instances, the storage device 118 stores data 120 that may be relevant to an NL query that is being processed by the application 108. However, the computing device 102 or the application 108 is unable to access the storage device 118 or the data 120 either because the computing device 102 is not operably connected to the storage device 118, or because the application 108 or a requesting user (not shown) is not allowed to access the storage device 118 or the data 120 based on at least one data security requirement. A data security requirement includes, but is not limited to, privilege, confidentiality, and a compliance policy. The inability of the computing device 102 or the application 108 to access the storage device 118 or the data 120 is represented by the dashed circle 124).

Embodiments described herein provide search answer extensibility for users in search operations. In the illustrated embodiment, the computing device 102 can receive an NL query for a search operation. The NL query can be received by the computing device 102 through a variety of techniques. In one embodiment, a user (not shown) inputs the NL query as a spoken or text input. For example, the user can type the NL query into a search box. Additionally or alternatively, the NL query may be selected from a list of suggested NL queries. In some embodiments, a list of one or more suggested NL queries is presented as the user enters the NL query into the search box (e.g., autocomplete), or in response to a document context. For example, an NL query can be suggested based on a context or topic at or around a location in a document in response to a user entering text into a search box while the user is in the process of writing the document. As a non-limiting nonexclusive example, a user is drafting a document on a sports team. As the user writes a paragraph on the coach of the sports team, the user stops writing the paragraph and begins to enter text into a search box. A list of suggested NL queries can be presented to the user based on the name of the coach and/or the name of the sports team.

In response to receiving the NL query, the NL query is analyzed to determine whether the NL query is to be processed by the application 108 or by another application (e.g., the application 116). The NL query is processed by the application 108 when the analysis of the NL query indicates the subject matter and/or the intent of the NL query relates to the data 106. The NL query is processed by the application 116 when the analysis of the NL query indicates the subject matter and/or the intent of the NL query relates to the data 120. When the NL query is to be processed by the application 116, the NL query is transmitted (or is caused to be transmitted) to the computing device 112 to enable the application 116 to process the NL query and produce a response to the NL query. The response to the NL query is transmitted (or is caused to be transmitted) back to the computing device 102 and the application 108, and the computing device 102 provides the response to an output device (not shown in FIG. 1). Thus, in the context of FIG. 1, the primary application is the application 108 and an assigned application is the application 116.

In some embodiments, a second computing device 126 can be operably connected to the computing devices 102, 112 through network 114. The computing device 126 stores one or more applications (collectively referred to as application 128). The analysis and/or processing of a NL query can be distributed between the application 108 and the application 128, or the computing device 102 may transmit the NL query to the computing device 126 for analysis and processing. In a non-limiting nonexclusive example, the computing device 126 is a cloud-based computing device and the application 128 provides a collaborative platform with a search application or search functionality, a virtual assistant, and/or a dialogue system. In other embodiments, the application 128 can be one or more applications discussed previously.

Each network 110, 114, 122 is illustrative of any suitable type of network, for example, an intranet, and/or a distributed computing network (e.g., the Internet) over which the computing devices 102, 112, 126 may communicate with each other and with the storage devices 104, 118. Additionally, the computing devices 102, 112, 126 can each be any suitable computing device, such as a mobile telephone, a smart phone, a tablet, a smart watch, a wearable computer, a personal computer a desktop computer, a laptop computer, a gaming device/computer (e.g., Xbox), a server, or a television. These types of computing devices are for example purposes only and should not be considered as limiting. Other embodiments are not limited to three computing devices 102, 112, 126 and two storage devices 104, 118. The system 100 can include any suitable number of computing devices, and/or storage devices.

In one non-limiting nonexclusive embodiment, the system 100 is included in a collaborative platform or application, and the data 106 is accessible by the computing devices 102, 112 within the collaborative application. Example data includes contacts (e.g., people), calendar, and files. The collaborative application can reside or execute on the computing device 102, and the computing device 112 is associated with a client. For example, the collaborative application (e.g., application 108) may be associated with an enterprise, and the computing device 112 may be associated with a client of the collaborative application (e.g., a department within the enterprise). For example, in one embodiment, the computing devices 102, 112, the applications 108, 116, the storage device 104, and the data 106 can be included in SharePoint® by Microsoft and the storage device 118 and the data 120 may be included in Azure® by Microsoft. The computing device 112 may be associated with a tenant (e.g., a client), the application 108 can be a primary application, and the application 116 may be assigned application.

In another non-limiting nonexclusive example, the system 100 is a collaborative environment, such as an enterprise (e.g., a business or organization). When a NL query is received by the application 108, the NL query is analyzed to determine whether the NL query is to be processed by the primary application 108, the assigned application 116, or both the primary and the assigned applications 108, 116. When the NL query is processed by the primary application 108, the data 106 is accessed to produce one or more responses to the NL query. When the NL query is processed by the assigned application 116, the data 120 is accessed to produce a response to the NL query. The data 120 may be included in the collaborative environment but protected based on a data security requirement, or the data 120 may be external to the collaborative environment. Thus, the NL query is transmitted (or is caused to be transmitted) to the assigned application 116 to enable the assigned application 116 to process the NL query to produce one or more responses to the NL query.

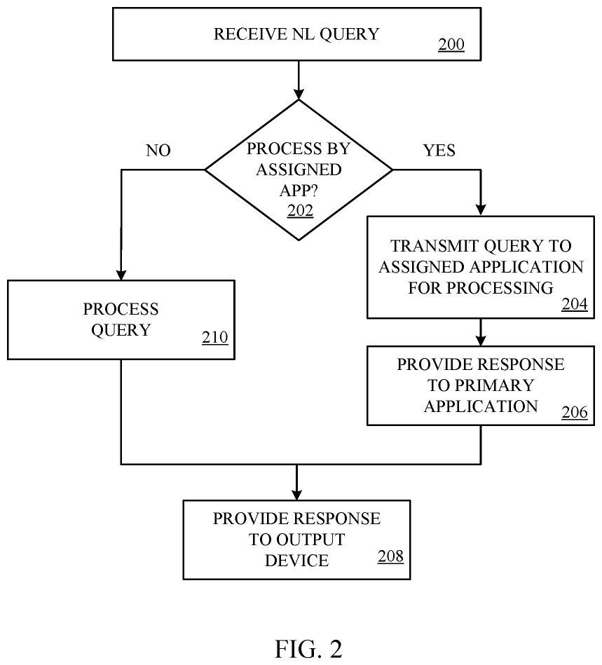

FIG. 2 illustrates a flowchart of a first example method of managing an NL query in accordance with some embodiments. The process is described in conjunction with a single assigned application or a primary application acting on the NL query. However, in other embodiments, a NL query is processed by multiple assigned applications in addition to, or in place of, the primary application.

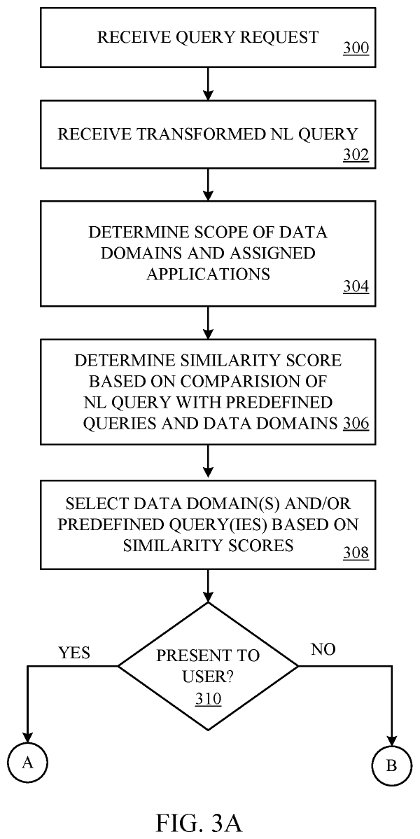

Initially, as shown in block 200, an NL query is received at a primary computing device. The NL query can be received via any suitable input. For example, the NL query may be a spoken input, a text input, or selected from a displayed list of suggested NL queries. A determination is made at block 202 as to whether the NL query triggers the use of an assigned application to process the NL query and provide a response to the NL query. As described in more detail in conjunction with FIGS. 3A-3B, in one embodiment the NL query can be compared to one or more predefined queries to determine a similarity score between the NL query and the one or more predefined queries. In one embodiment, the comparison ascertains how similar semantically the NL query is to the predefined queries and computes similarity scores that represent the semantic similarity. The predefined queries are associated with the assigned applications that are considered when the NL query is analyzed.

Additionally, in some embodiments, the NL query is also compared to the data that is accessible by the primary application (e.g., data 106 in FIG. 1). The data can be clustered or grouped by skills or categories based on the applications that access, create, store, and/or use the data. Example categories include, but are not limited to, mail, contacts, and calendar data. In such example embodiments, the phrase “data domain” refers to a group of categorized data. The comparison of the NL query to the data domains is performed to determine a similarity score (e.g., a semantic similarity score) between the NL query and some or all of the data domains. In another embodiment, one or more predefined queries for each category can be used in place of, or in addition to, the data domains.

The data domain or the predefined query with the highest similarity score can be used to ascertain whether the primary application or an assigned application will process the NL query. If the NL query is to be processed by an assigned application, the method passes to block 204 where the NL query is transmitted, or is caused to be transmitted, to the assigned application for processing to produce a response to the NL query. The assigned application may be executing or residing on the same computing device (e.g., the primary computing device) as the primary application, or the primary and the assigned applications can be executing or residing on different computing devices. The response to the NL query is then transmitted (or is caused to be transmitted) back to the primary application at block 206. The response is provided to an output device operably connected to the primary computing device (block 208). For example, in one embodiment, the response is displayed in a graphical user interface on a display screen operably connected to the primary computing device. In another embodiment, the response is provided to a speaker operably connected to the computing device to produce an audible output.

When the determination at block 202 is that the NL query does not trigger the use of an assigned application, which means the NL query is to be processed by the primary application, the process continues at block 210 where the query is processed by the primary application to produce a response. The method then continues at block 208 where the response is provided to an output device.

In some embodiments, multiple data domains and/or predefined queries can be used to determine whether the primary application, one or more assigned applications, or both the primary application and one or more assigned applications will process a NL query. In one embodiment, the data domains and/or predefined queries that are associated with the top N similarity scores (N≥2), are used to determine whether the primary application, one or more assigned applications, or both the primary application and one or more assigned applications will process the NL query. In another embodiment, the data domains and/or predefined queries that are associated with similarity scores above a threshold value are used to determine which applications will process the NL query.

In some implementations, the data domains and/or the predefined queries that are associated with the top N similarity scores (N≥2) or that have similarity scores above a threshold value can be presented to a user to enable the user to select a particular predefined query or data domain. The determination of whether the primary application or an assigned application will process the NL query is based on the selected predefined query or the selected data domain. These operations are illustrated in the example method shown in FIGS. 3A-3B.

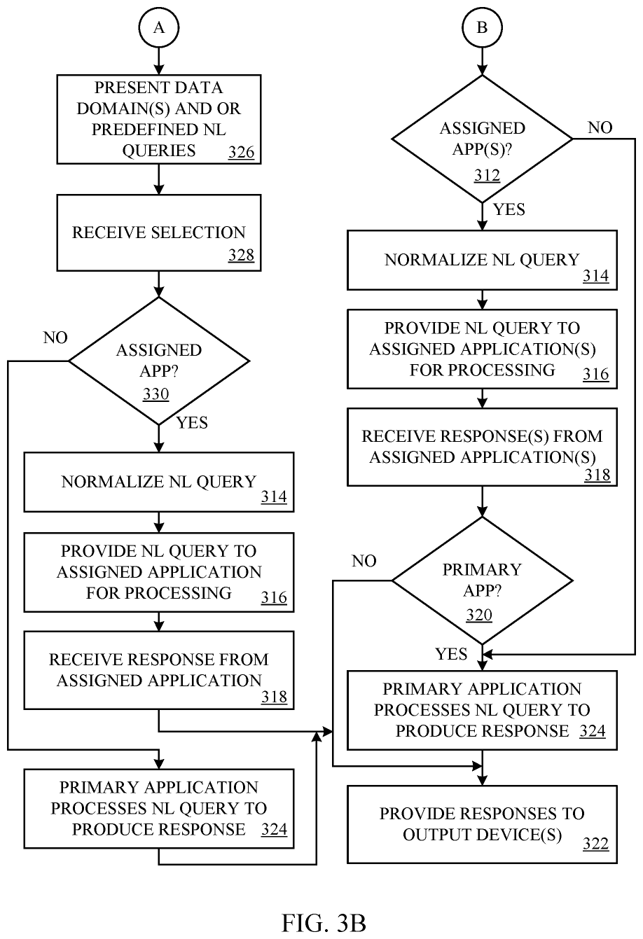

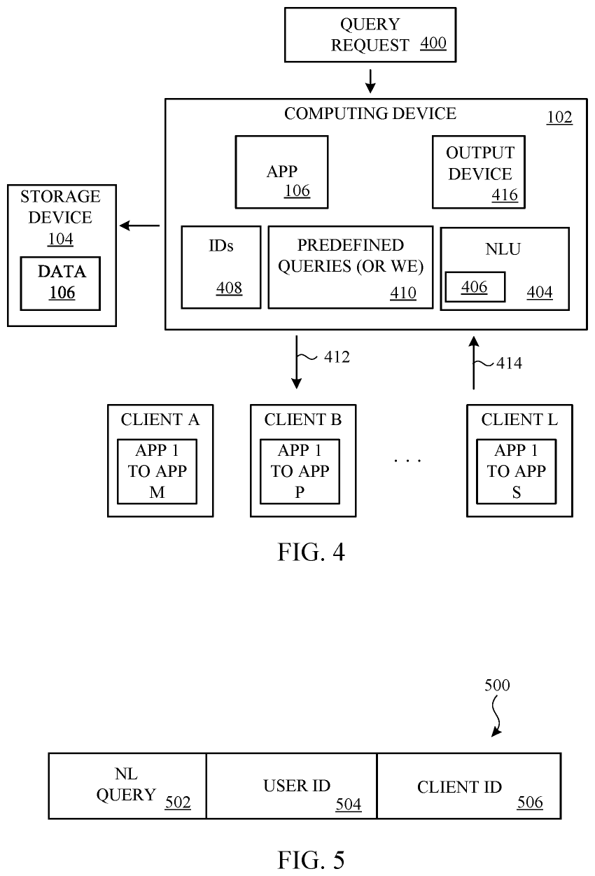

FIGS. 3A-3B depict a flowchart of a second example method of managing an NL query in accordance with some embodiments. The process is described as using either a single application or multiple applications to process the NL query. The method shown in FIGS. 3A-3B is described in conjunction with FIGS. 4 and 5.

Initially, as shown in block 300, a query request is received at a primary computing device. FIG. 4 illustrates an example system for triggering an assigned application to extend search functionality in some embodiments. As shown in FIG. 4, the query request 400 is received by the computing device 102. FIG. 5 depicts an example query request in accordance with some embodiments. The query request 500 includes the NL query 502, a user identifier 504, and a client identifier 506. The user identifier 504 includes data that identifies or is otherwise associated with the user submitting the NL query 502. The user identifier 504 can be used to define the scope of possible assigned applications to be considered to process the NL query 502. In one embodiment, the user identifier is used to identify which applications and/or data the user can access and/or not access.

The client identifier 506 includes data that identifies one or more clients in the system (e.g., a collaborative environment or platform). In some instances, the user that provided the NL query is associated with a client. For example, in an enterprise environment, the user may work in the marketing department, whereby the marketing department is the client. In some instances, the user is associated with the marketing department and a project in the enterprise, in which case the client identifier 506 includes data for both the marking department and the project. Alternatively, in a collaborative application such as SharePoint®, the user may be associated with the human resources (HR) department (e.g., a tenant) such that the HR department is the client. The client identifier 506 may be used to identify or define the scope of possible assigned applications to be considered to receive and process the NL query 502.

Each client can have one or more assigned applications that can process an NL query. For example, as shown in FIG. 4, the system 402 includes Client A through Client L. Client A includes applications 1 to M, where M≥1. Client B includes applications 1 to P, where P≥1. Client L includes applications 1 to S, where S≥1. Some or all of the applications of each client can be assigned applications. Alternatively, some or all of the applications in a portion (less than all) of the clients may be assigned applications.

Returning to FIG. 3A, a transformed NL query can be received at block 302. In some embodiments, the NL query in the query request is transformed into one or more word embeddings that represent the NL query. Typically, the NL query is transformed into word embedding(s) by mapping each word in the NL query to a vector of real numbers. Word embeddings can make it easier to process NL queries by adding or subtracting the vectors (or by performing other mathematical operations). In one embodiment, the NL query is transformed into word embedding(s) by a natural language processing or natural language understanding (NLU) application 404. Example contextual word embedding models that can be used to transform the NL query and the predefined queries into word embeddings include, but are not limited to, the Turing contextual natural language models such as TNLR and TULR.

The scope of the possible data domains based on the NL query is determined at block 304 based on an intent of the NL query (e.g., the subject matter or a goal of the NL query). Additionally, the scope of possible assigned applications to be considered for processing the NL query is also determined at block 304 based on at least one of the user identifier (e.g., 504 in FIG. 5) or the client identifier (e.g., 506 in FIG. 5). In one embodiment, the client identifiers map to particular clients (e.g., Client A, Client B, etc.), and the identified scope includes one or more possible assigned applications associated with that client. The NL query is compared with one or more predefined queries associated with each possible assigned application and with the possible data domains, and a similarity score is computed for each predefined query and/or data domain (block 306). Typically, the higher the similarity score, the more similar the NL query is to the predefined query or the data domain.

Based on the similarity scores, predefined queries and/or data domains are selected at block 308. For example, in one embodiment, the predefined queries and/or data domains that are associated with the top X similarity scores can be selected at block 308, where X≥2. Alternatively, the predefined queries and/or the data domains that have similarity scores that are equal to or greater than a threshold value may be selected. Example similarity models that may be used to compute the similarity scores include, but are not limited to, the Cosine model and the KNN model.

In the embodiment shown in FIG. 4, the NLU application 404 transforms the NL query into the one or more word embeddings. The NLU application 404 includes a triggering application 406 that determines whether the NL query (or the word embedding(s) that represent the NL query) is to be processed by the primary application and/or by one or more assigned applications. The triggering application 406 determines the intent of the NL query and compared the intent to the data domains to determine the scope of possible data domains. The triggering application 406 accesses the user and/or client identifiers 408 to determine the scope of the possible assigned applications and/or which client or clients are associated with the client identifier. Based on this determination, the triggering application 406 compares the NL query with the possible data domains (e.g., data 106 in FIG. 4), the predefined queries (or word embeddings (WE) 410 that are associated with the identified client(s) and/or the possible assigned application(s) and computes a similarity score for each predefined query and data domain. In some embodiments, the predefined queries are pre-stored by a developer of an assigned application, by the client (e.g., an administrator), or by a combination of both a developer and the client. As discussed earlier, the predefined queries (or the WE) 410 can be clustered or grouped by client and then by application to enable the comparison process to be more efficient. In one embodiment, the predefined queries 410 are transformed into WEs prior to storage such that the WEs that represent the predefined queries are stored.

Returning to FIG. 3A, a determination is made at block 310 as to whether the predefined queries and/or the data domains that were selected at block 308 are to be presented to a user. If not, the process passes to block 312 where a determination is made as to whether the NL query is to be processed by one or more assigned applications. This determination is based on the predefined queries and/or data domains that were selected at block 308. If one or more of the selected predefined queries is associated with an assigned application, the NL query is to be processed by the assigned application associated with each selected predefined query. In such embodiments, the method continues at block 314 where the NL query is normalized. Normalizing the NL causes the NL query (or the word embeddings that represent the NL query) to be organized or arranged in a format that is recognized and accepted by the assigned application(s) that will process the NL query.

The NL query is then routed to the one or more assigned applications for processing (block 316), and a response is received from each assigned application (block 318). A determination is made at block 320 as to whether the NL query is to be processed by the primary application. If not, the process passes to block 322 where the responses to the NL query are provided to one or more output devices operably connected to the primary computing device. In one embodiment, the response is displayed via a graphical user interface on a display screen. In another embodiment, the response is provided to a speaker to produce an audible output.

When a determination is made at block 320 that the primary application will process the NL query, the method continues at block 324 where the primary application processes the at least one NL query to produce a response to each NL query. The response is then provided to one or more output devices operably connected to the primary computing device (block 322).

Returning to block 310, when a determination is made that the predefined queries and/or data domains are to be presented to a user, the process passes to block 326 where the predefined queries and/or data domains are provided to one or more output devices. The predefined queries can be presented to the user via a variety of techniques. In one example embodiment, the predefined queries and/or data domains are displayed in a graphical user interface. Additionally or alternatively, the predefined queries and/or data domains are audibly output on a speaker or speakers.

A selection of a predefined query or a data domain is received at block 328. A user may select the predefined query or the data domain using various techniques. In one example embodiment, a graphical user interface can present a selection mechanism that enables the user to select a predefined query or a data domain. The selection mechanism may be checkboxes or dialog boxes, or the predefined queries and/or data domains can be displayed as selectable links. Additionally or alternatively, the selection can be a spoken selection that is received by a microphone.

Based on the selection at block 328, a determination is made at block 330 as to whether an assigned application is to process the NL query. If so, the process passes to block 314 and blocks 314, 316, 318, and 322 are performed. When a determination is made at block 330 that an assigned application will not process the NL query (e.g., the primary application will process the NL query), the method continues at block 324 and blocks 324 and 322 are performed.

Referring now to FIG. 4, the triggering application 406 can select the predefined queries and/or the data domains based on the similarity scores and determine whether the NL query triggers the use of one or more assigned applications. The triggering application 406 can also normalize the NL query (or the corresponding word embeddings) when a normalization process is to be performed. The arrow 412 illustrates the routing of the NL query to one or more clients (e.g., Client A, Client B, . . . , or Client L) and the associated assigned application(s) for processing, and the arrow 414 represents the assigned application(s) providing responses to the NL query to the computing device 102. An output device 416 is used to present the response(s) to the user.

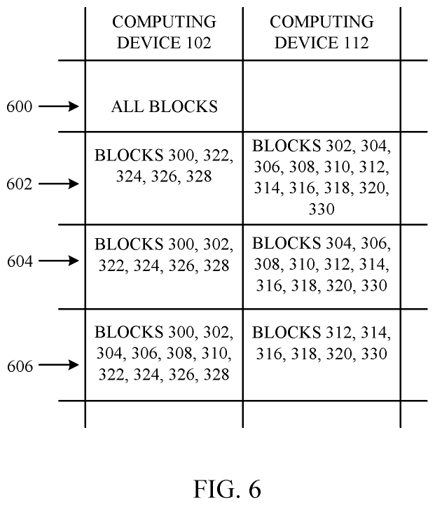

FIG. 6 illustrates example implementations of the method shown in FIGS. 3A-3B in accordance with some embodiments. The implementations are described in conjunction with the primary computing device 102 and the computing device 112 in FIG. 1. In implementation 600, all of the blocks depicted in FIGS. 3A-3B are performed by the primary computing device 102. Implementations 602, 604, 606 illustrate different example ways in which the blocks in FIGS. 3A-3B can be distributed between the primary computing device 102 and the assigned computing device 112. In the example implementation 602, the primary computing device 102 executes blocks 300, 322, 324, 326, and 328 while the assigned computing device 112 implements blocks 302, 304, 306, 308, 310, 312, 314, 316, 318, 320, and 330. Alternatively, the primary computing device 102 executes blocks 300, 302, 322, 324, 326, and 328 while the assigned computing device 112 implements blocks 304, 306, 308, 310, 312, 314, 316, 318, 320, and 330 in the example implantation 604. In yet another alternative embodiment, the primary computing device 102 executed blocks 300, 302, 304, 306, 308, 310, 322, 324, 326, and 328 and the assigned computing device 112 implements blocks 312, 314, 316, 318, 320, and 330 (implementation 606). Other embodiments are not limited to the illustrated implements shown in FIG. 6. Different configurations for distributed processing can be realized in additional embodiments.

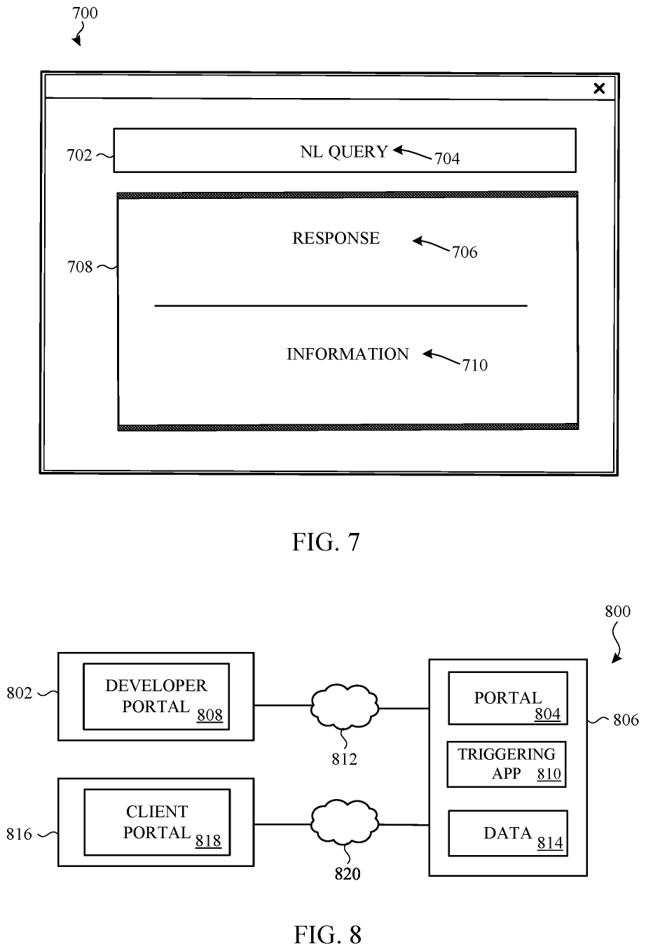

FIG. 7 depicts an example graphical user interface for providing a response to an NL query in accordance with some embodiments. The graphical user interface (GUI) 700 can include a panel 702 that presents the NL query 704 that was submitted by a user. The GUI 700 presents the response 706 in a panel 708. The panel 702 and the panel 708 can be the same panel or separate panels. In some embodiments, when an assigned application processes the NL query 704, the GUI 700 presents information 710 associated with the client associated with the assigned application and/or the assigned application. For example, the information 710 can include the name of the client and/or the name of the assigned application. Additionally, the information 710 may present the similarity score associated with the comparison of the NL query 704 to the predefined query associated with the assigned application.

In some embodiments, a developer and/or a client (e.g., administrator) creates and manages the assigned applications and predefined queries. The assigned applications, predefined queries, application and query data, and the information (e.g., information 710) can be uploaded or registered with a system such as a collaborative platform or an enterprise. For example, application and query data such as one or more constraints can be uploaded and associated with predefined queries and assigned applications. A constraint provides one or more factors that define when an assigned application is to be used to process an NL query, or that impact the computation of the similarity score for the predefined queries. For example, a client may prioritize the use of one assigned application over another assigned application by associating a weight with the assigned applications. Additionally or alternatively, weights can be associated with the predefined queries that impact the computation of the similarity scores. A positive or a negative weight may be applied to a similarity score or considered when computing the similarity score to either increase or decrease the similarity score. A weight indicates a confidence level in a predefined query. For example, a predefined query that has a higher selection rate based on the similarity score may be assigned a higher confidence level compared to a predefined query that has never been selected or used. In some embodiments, a constraint may specify that one or more words in a predefined query should not trigger the use of an assigned application or should not be considered when determining whether an NL query is to be processed by an assigned application.

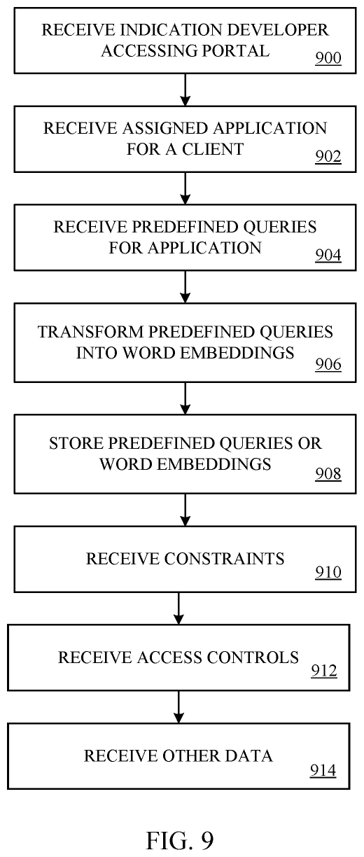

FIG. 8 illustrates an example system enabled for interaction by a developer and/or client associated with an assigned application in accordance with some embodiments. The system enables a developer and/or a client to upload assigned applications, upload predefined queries, modify queries, and provide other data and information associated with the assigned applications and the predefined queries. In some instances, the developer and the client administrator are the same entity (e.g., same person or persons). The system 800 includes a computing device 802 that is associated with a developer. The developer can access a portal 804 on the computing device 806 through a developer portal 808 on the computing device 802. Data is exchanged between the computing device 802 and the computing device 806 over one or more networks (represented by network 812). In one embodiment, the computing device 806 is a cloud computing device.

The portal 804 at the computing device 806 receives data that is uploaded from the computing device 802. The data may be used by a triggering application 810 to determine whether an NL query triggers the use of an assigned application to process the NL query and provide a response to the NL query. Once uploaded, the assigned application and the predefined queries are stored in a client data repository 814 within or operably connected to the computing device 806. In one non-limiting example, predefined queries are grouped by the assigned application associated with the predefined queries, such as queries that relate to an aspect of an HR department (e.g., paid holidays and vacation days). In another example, predefined queries are clustered by the subject matter, such as a project name. In such embodiments, the predefined queries can span multiple clients and/or multiple assigned applications (e.g., product development and finance and associated assigned applications).

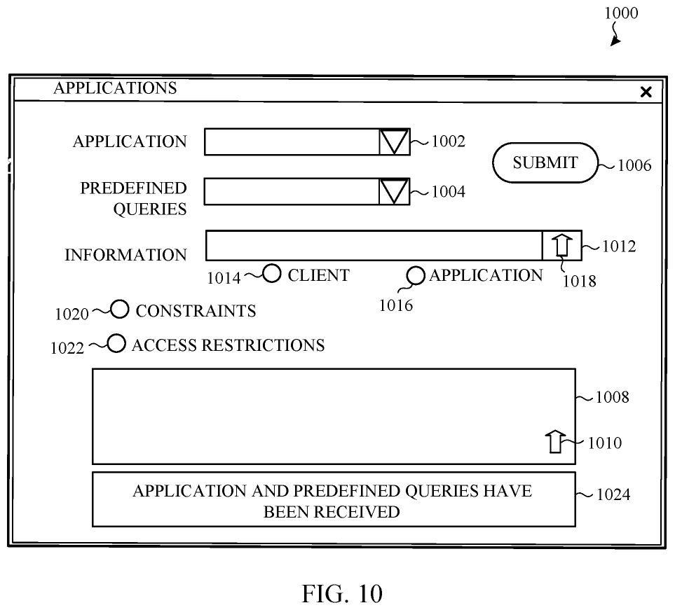

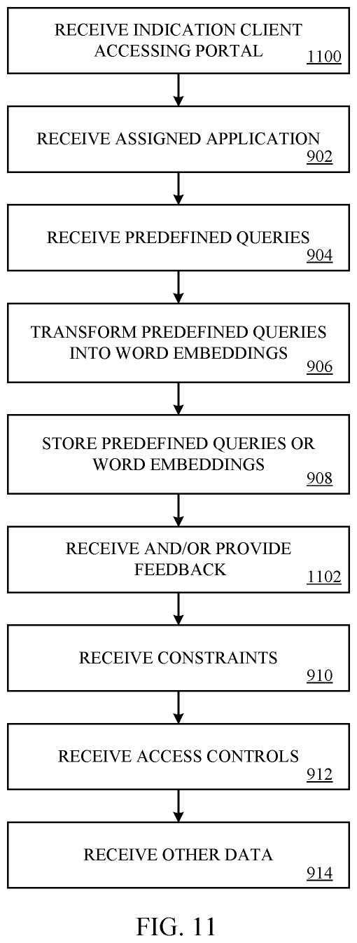

The developer portal 808 enables the developer to submit the assigned applications and the predefined queries that are associated with the assigned applications, to submit information associated with the assigned applications and the predefined queries, and to interact with the data in the client data repository 814. As described earlier, the predefined queries are compared with an NL query to determine if the NL query is to be processed by one or more assigned applications associated with the predefined queries that are selected based on the computed similarity scores. Example embodiments of operations that can be performed by a developer are described in more detail in conjunction with FIGS. 9 and 10.

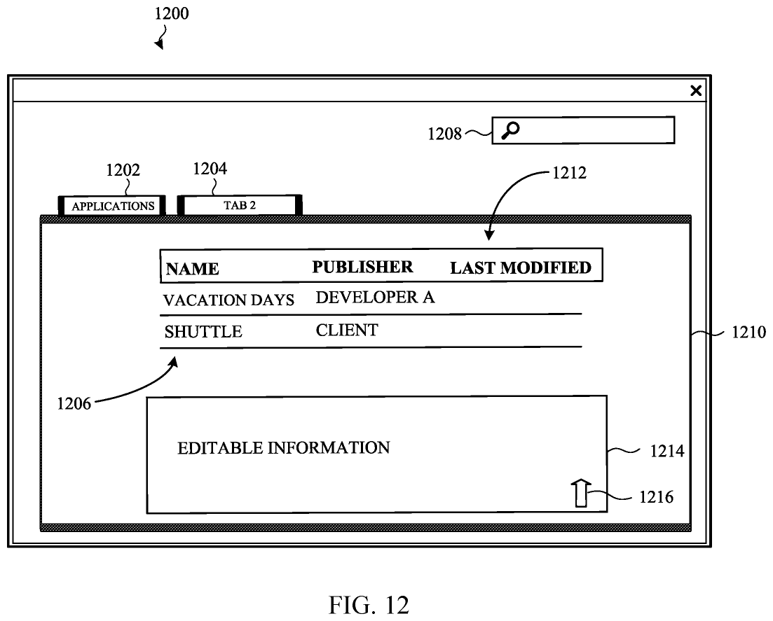

The system 800 can also include a computing device 816 that is associated with a client. The client (e.g., a client administrator) can access the portal 804 on the computing device 806 through a client portal 818 on the computing device 816. Data is exchanged between the computing device 816 and the computing device 806 over one or more networks (represented by network 820). In some embodiments, such as when the developer and the client administrator are the same entity, computing device 816 may be the same device as computing device 802. As will be described in more detail in conjunction with FIGS. 11-13, the client portal 818 enables the client to submit predefined queries that are associated with an assigned application, to modify predefined queries, and to otherwise interact with the data in the client data repository 814.

FIG. 9 depicts a flowchart of a first method of enabling a developer to provide information associated with an assigned application in accordance with some embodiments. Some of the blocks are performed in response to data that is received from a developer (e.g., received via a developer portal). Initially, as shown in block 900, an indication that a developer has requested access to, or is accessing a developer portal (e.g., developer portal 808 in FIG. 8) is received. In some instances, the developer portal can be provided (or caused to be provided) at block 900 based on a request that is received from a developer. An assigned application or information that identifies the assigned application (e.g., a storage location of the assigned application) is received at block 902 when a developer uploads an assigned application. Predefined queries associated with an assigned application are received at block 904 when the developer uploads the predefined queries. In one embodiment, the predefined queries are associated with the assigned application submitted at block 902. In another embodiment, the predefined queries are associated with an existing assigned application (e.g., an assigned application currently available to process NL queries). For example, the submitted queries can be new queries for an existing assigned application and a developer identifies the assigned application when the queries are submitted. In the system of FIG. 8, the assigned application and/or the predefined queries are received by the computing device 806.

Next, as shown in block 906, the received predefined queries can be transformed into word embeddings that represent the predefined queries. The word embeddings or the predefined queries are then stored in a storage device at block 908. In one embodiment, the predefined queries or the word embeddings are stored in the client data repository 814 in FIG. 8.

Next, as shown in block 910, one or more constraints for a predefined query and/or an assigned application are received. Each constraint can provide one or more factors that define when an assigned application is to be used to process an NL query. For example, as described previously, a weight can be associated with one or more predefined queries. Additionally or alternatively, data (e.g., a weight) may be associated with an assigned application to indicate a preference for the use of the assigned application compared to another application.

Access controls for an assigned application and/or for predefined queries may be received at block 912. The access controls can restrict some users from having a particular assigned application process an NL query, or from receiving responses that contain particular client data. Additionally, certain users can be given full access to all assigned applications and/or client data. In one embodiment, one or more access controls is included in a user identifier (e.g., user identifier 504 in FIG. 5). In some instances, a triggering application can associate the access controls with respective user identifiers (e.g., write the access controls into the user identifier).

Other data associated with an assigned application and/or predefined queries may be received at block 914. Example data includes, but is not limited to, information associated with an assigned application such as a name of the assigned application or a creation date of the assigned application, a modification date of a predefined query, the name of the client associated with an assigned application, the function or role of the client (e.g., in an enterprise), and the function of an assigned application.

In some embodiments, select blocks in FIG. 9 are not performed. For example, a developer may not provide constraints in one embodiment. In another embodiment, the predefined queries are not transformed into word embeddings. Additionally or alternatively, the blocks may be arranged in a different order or some blocks can be performed simultaneously.

FIG. 10 illustrates an example graphical user interface for enabling a developer to provide information associated with an assigned application in accordance with some embodiments. The GUI 1000 is presented to a developer when the developer accesses the developer portal (e.g., developer portal 808 in FIG. 8). The GUI 1000 is described as including particular input elements, such as drop-down menus, buttons, dialog boxes, panels, icons, and text boxes. Different types of input elements can be used in other embodiments.

In the illustrated embodiment, a drop-down menu 1002 is used by the developer to select an assigned application to submit. A drop-down menu 1004 may also be used by the developer to select a file of predefined queries (“predefined queries file”) to submit. Once the assigned application and/or the predefined queries file is selected, the developer selects the button 1006 labeled “submit” to submit the assigned application and/or the predefined queries file.

In some embodiments, the drop-down menu 1002 can be used by the developer to select a previously uploaded assigned application, and the drop-down menu 1004 may be used by the developer to select a previously submitted predefined queries file. For example, a developer can select a previously submitted queries file in order to modify one or more queries. When an assigned application is selected, information associated with the assigned application can be presented in the text box 1008. When a predefined queries file is selected, the predefined queries and/or the information associated with the predefined queries can be presented in the text box 1008. The developer can modify the predefined queries or the information when presented in the text box 1008. When all of the modifications are complete, the developer may select the ‘submit” icon 1010 to store the data in a client data repository. Once stored, the assigned application, the predefined queries, and the information are available for use by a triggering application.

The text box 1012 can be used by the developer to submit information that is associated with a new or an existing application. Information such as the name of the assigned application, the name of the client associated with an assigned application, a creation or modification date of an assigned application, the most recent version of an assigned application, the function or role of the client associated with an assigned application, and the function of an assigned application can be entered into the text box 1012. In some embodiments, predetermined data fields are presented in addition to the text box 1012, or in place of the text box 1012, that a developer can fill in with the respective information. Some or all of the data fields may pre-populate with the information that is received from the system (e.g., by automatically pulling the information from the application). Additionally or alternatively, radio buttons 1014, 1016 can enable the developer to select either “client” or “assigned application” to associate the information entered in the text box 1012 with either a client or an assigned application. The developer selects the “submit” icon 1018 to store the information in a client data repository.

A radio button 1020 can be selected by the developer to enable the developer to add constraints to an assigned application and/or to one or more predefined queries. As described earlier, a constraint can provide factors that define when an assigned application is to be used to process an NL query. For example, a weight can be associated with a predefined query and act as a constraint. In some embodiments, present constraints can be presented (e.g., in the text box 1008) in response to the receipt of a selection of the radio button 1020 that enable the developer to select to enter constraint values. The preset constraints may be presented in the GUI 1000 (e.g., in a panel) or in a separate GUI.

A radio button 1022 can be selected by the developer to enable the developer to add access controls to an assigned application and/or to one or more predefined queries. The access controls can restrict the triggering of the use of a particular assigned application process an NL query, or restrict a user from receiving responses that contain particular client data. Additionally, certain users can be given full access to all assigned applications and/or client data. In some embodiments, the text box 1008 can present a list of users along with preset access controls that enable the developer to select a user and enter the access controls for that user. Alternatively, the preset access controls can be presented in the GUI 1000 or in a separate GUI in response to the receipt of a selection of the radio button 1020. In some embodiments, an access control file is uploaded that contains the access control values for a group of users.

In some embodiments, a notification panel 1024 can present notifications to the developer regarding any of the operations performed by the developer. For example, the notification panel 1024 shown in FIG. 10 displays a notification that informs the developer that an assigned application and predefined queries have been submitted. Notifications for the other operations a developer can perform via the GUI 1000 can be presented in the notification panel 1024. The notifications may inform the developer that an operation was successful or was unsuccessful (e.g., the assigned application failed to upload, or an entered constraint is not applicable).

FIG. 11 depicts a flowchart of an example method of enabling a client to provide information for an assigned application in accordance with some embodiments. The blocks are performed in response to data that is received from a client (e.g., received via a client portal from a client administrator). Some of the blocks are the same as blocks shown in FIG. 9. As such, these blocks have the same reference numbers and are not described in detail herein.

Initially, as shown in block 1100, an indication is received that a client has requested access to, or is accessing a client portal (e.g., client portal 818 in FIG. 8). In some instances, the client portal can be provided (or caused to be provided) at block 1100 based on a request that is received from a client. An assigned application is received at block 902. For example, a client may add functionality to its assigned application, or may submit a new assigned application when the client, and not the developer, is providing or managing the assigned application (or the client and the developer are the same entity). New and/or modified predefined queries are received at block 904.

The received predefined queries can be transformed into word embeddings that represent the predefined queries at block 906. The word embeddings or the predefined queries are then stored in a storage device at block 908. In one embodiment, the predefined queries or the word embeddings are stored in the client data repository 814 in FIG. 8.

Users that receive responses to an NL query can provide feedback on the user experience (e.g., the quality of the responses), or the triggering application can provide feedback regarding the assigned application and/or the predefined queries. For example, the triggering application may identify which defined queries have the highest similarity scores, the frequency at which each predefined query is selected (or not selected) based on the similarity scores (e.g., block 308 in FIG. 3A), or how often each predefined query has a similarity score above a threshold value. In some instances, the triggering application can identify statistics on assigned applications, such as a count of how often each assigned application is used to process an NL query, and which predefined queries most often cause the predefined application to be used. In one embodiment, the feedback can be received and/or provided to the client at block 1102. For example, the feedback may be presented (or caused to be presented) via the client portal.

Example feedback that can be received from the users of the assigned applications includes feedback on whether the responses received based on an NL query answer the query or not, which may indicate whether the assigned application that processed the NL query is the appropriate assigned application to process the NL query. Additionally, feedback regarding the user experience with the search operation may be received, such as which search results are selected (or not selected) by the user. Again, this can indicate whether the assigned application that processed the NL query is the appropriate assigned application to process the NL query. Those skilled in the art will appreciate that additional types of feedback may be received from the triggering application or the users in other embodiments.

Next, as shown in block 910, the client can input constraints for an assigned application and/or for one or more predefined queries. In some situations, a constraint may be based on the feedback that was received and/or provided (e.g., displayed) at block 1102. Additionally or alternatively, a constraint can provide factors that define when an assigned application is to be used to process an NL query.

Access controls may be received at block 912. Other data associated with an assigned application and/or predefined queries may be received at block 914. Example data includes, but is not limited to, information associated with an assigned application such as a name of the assigned application or a creation date of the assigned application, a modification date of a predefined query, the name of the client associated with an assigned application, the function or role of the client (e.g., in an enterprise), and the function of an assigned application. As discussed earlier, a triggering application can associate the access controls with respective user identifiers (e.g., write the access controls into the user identifier).

In some embodiments, select blocks in FIG. 11 are not performed. For example, access controls may not be received from a client in one embodiment. In another embodiment, the predefined queries are not transformed into word embeddings. Additionally or alternatively, the blocks may be arranged in a different order or some blocks can be performed simultaneously.

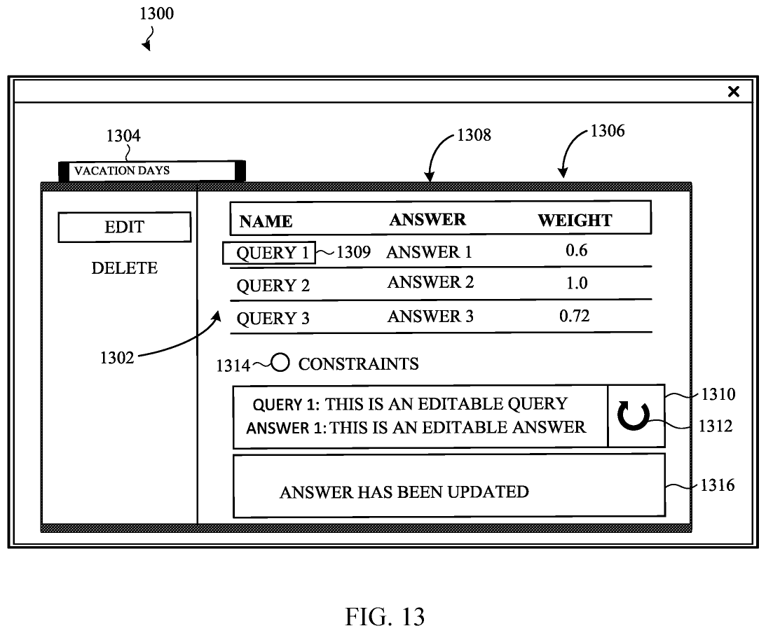

FIG. 12 illustrates a first example graphical user interface for enabling a client to provide information associated with an assigned application in accordance with some embodiments. The GUI 1200 is described as including particular input elements, such as icons and panels. Different types of input elements can be used in other embodiments.

In one embodiment, the GUI 1200 is presented to a client (e.g., an administrator) when an indication that the client has requested access to, or is accessing the client portal (e.g., client portal 818 in FIG. 8). The GUI 1200 includes tabs 1202, 1204 that each provide functionality to a client. In the illustrated embodiment, the Applications tab 1202 is selected. In FIG. 12, the GUI 1200 also includes second tab (Tab 2) 1204 that can provide functionality such as notes, tasks, and conversations. Other embodiments can include any number of tabs.

In response to the selection of the Applications tab 1202, a list of the assigned applications 1206 associated with the client are presented. In some embodiments, a client can search for a particular assigned application using the search box 1208 instead of, or in addition to, selecting the Applications tab 1202. The list of the assigned applications 1206 is displayed in the panel 1210. In the illustrated embodiment, the client is an HR department in a company, and the HR department has an assigned application named Vacation Days and an assigned application entitled Shuttle. For example, the assigned application Vacation Days may provide information on the use of vacation days, the number of vacation days, and other information associated with vacation days. The assigned application Shuttle may provide information on a shuttle service that is provided by the client, such as the stops and the times the shuttle departs from the stops.

The panel 1210 may list other information 1212 associated with the assigned applications. For example, Developer A published or provided the Vacation Days assigned application, and the client provided the Shuttle assigned application. A Last Modified date is also presented in the panel 1210. In other embodiments, additional or different information that is associated with the assigned applications can be displayed in the panel 1210.

Information associated with a selected assigned application can be presented in the panel 1214. For example, when the assigned application Vacation Days is selected, information such as the function of the assigned application, the creation date of the assigned application, a version number of the assigned application, and any constraints or access controls associated with the Vacation Days assigned application are presented. In some embodiments, the client can add information or modify the information while the information is displayed in the panel 1214. When the modifications to the information are complete, the client selects the submit icon 1216 to cause the information to be submitted and stored in a client data repository. Once stored, the information is available for use by a triggering application and/or for presentation in the GUI 1200.

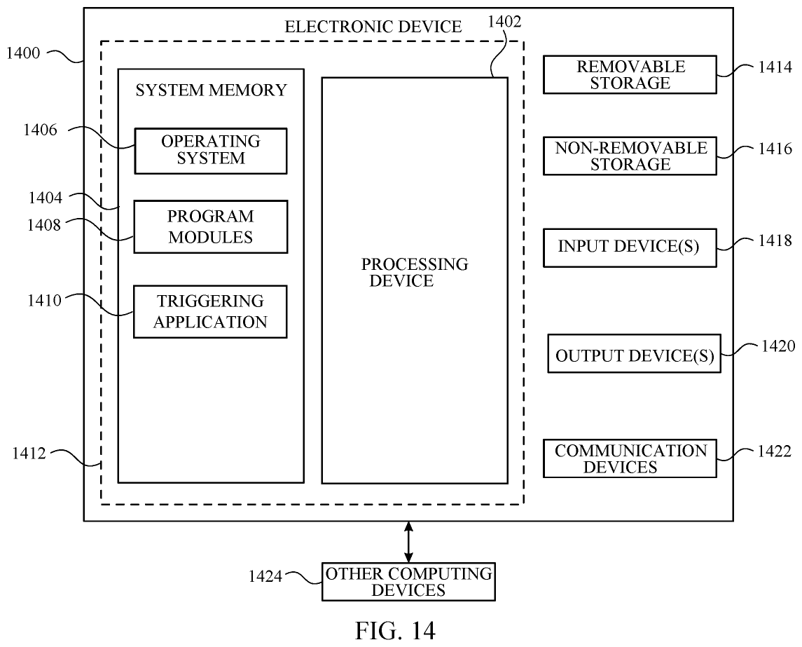

FIG. 13 depicts a second example graphical user interface for enabling a client to provide information associated with an assigned application in accordance with some embodiments. The GUI 1300 is described as including particular input elements, such as icons and panels. Different types of input elements can be used in other embodiments.

In one embodiment, the GUI 1300 is presented to a client (e.g., a client administrator) when a request to access the client portal is received, or an indication that the client is accesses the client portal (e.g., client portal 818 in FIG. 8). The GUI 1300 displays information associated with the predefined queries for an assigned application. In the illustrated embodiment, a list of predefined queries 1302 for the assigned application Vacation Days 1304 is presented along with a weight 1306 that has been assigned to each predefined query. An answer 1308 is listed for each predefined query.

When a particular predefined query is selected (e.g., Query 1 as represented by the box 1309 around Query 1), the predefined query and the answer are presented in the panel 1310. The displayed predefined query and the answer can be modified or deleted while displayed in the panel 1310. Once the modifications are complete, the client can select the submit icon 1312 to cause the query and the answer to be uploaded and stored in a client data repository.

In some embodiments, constraints for a predefined query can be added or modified when the predefined query and the radio button 1314 are selected and the predefined queries are presented in the panel 1310. For example, preset constraints may be presented in the panel 1310 or in a separate panel to enable the client to add any new constraints.

In some embodiments, a notification panel 1316 can present a notification to the client regarding any of the operations performed by the client. For example, the notification panel 1316 shown in FIG. 13 displays a notification that informs the client that the answer displayed in the panel 1310 has been updated. Notifications for the other operations a client can perform via the GUI 1300 can be presented in the notification panel 1316. The notifications may inform the client that an operation was successful or was unsuccessful (e.g., entered constraint is not appropriate).

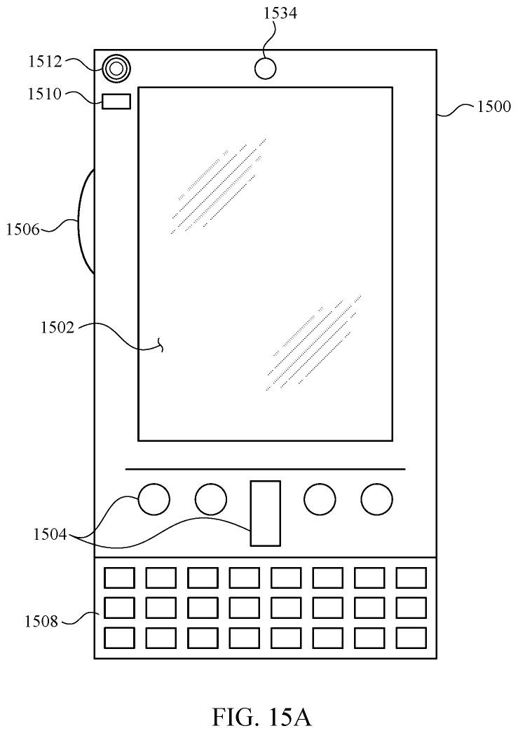

FIGS. 14-16 and the associated descriptions provide a discussion of a variety of operating environments in which aspects of the disclosure may be practiced. However, the devices and systems illustrated and discussed with respect to FIGS. 14-16 are for purposes of example and illustration and are not limiting of a vast number of electronic device configurations that may be utilize for practicing aspects of the disclosure, as described herein.

FIG. 14 is a block diagram illustrating physical components (e.g., hardware) of an electronic device with which aspects of the disclosure may be practiced. In a basic configuration, the electronic device 1400 may include at least one processing device 1402 and a memory 1404. Any suitable processing device 1402 can be used. For example, the processing device 1402 may be a microprocessor, an application specific integrated circuit, a field programmable gate array, or combinations thereof.

Depending on the configuration and type of the electronic device 1400, the memory 1404 may comprise, but is not limited to, volatile storage (e.g., random access memory), non-volatile storage (e.g., read-only memory), flash memory, or any combination of such memories. The memory 1404 may include a number of program modules and data files, such as an operating system 1406, program modules 1408, and a triggering application 1410. While executing on the processing device 1402, the triggering application 1410 may perform and/or cause to be performed processes including, but not limited to, the aspects as described herein.

In some embodiments, the triggering application 1410 can be any suitable type of machine learning or language understanding application that learns over time and improves the triggering process. For example, the triggering application 1410, executing on the processing device 1402, can learn which NL queries (or which words in the NL queries) trigger the use of an assigned application to process the NL query. Additionally, the triggering application can quickly adapt to new assigned applications. Using the learned aspects of the triggering process, over time the triggering application 1410 becomes more efficient and effective in determining whether to use an assigned application to process an NL query, in selecting which assigned application is to be used to process an NL query, and which predefined queries (or which words in the predefined queries) trigger the use of the assigned application.

The operating system 1406, for example, may be suitable for controlling the operation of the electronic device 1400. Furthermore, embodiments of the disclosure may be practiced in conjunction with a graphics library, other operating systems, or any other application program and is not limited to any particular application or system. This basic configuration is illustrated in FIG. 14 by those components within a dashed line 1412.

The electronic device 1400 may have additional features or functionality. For example, the electronic device 1400 may also include additional data storage devices (removable and/or non-removable) such as, for example, magnetic disks, optical disks, or tape. Such additional storage is illustrated in FIG. 14 by a removable storage device 1414 and a non-removable storage device 1416.

The electronic device 1400 may also have one or more input device(s) 1418 such as a keyboard, a trackpad, a mouse, a pen, a sound or voice input device, a touch, force and/or swipe input device, etc. The output device(s) 1420 such as a display, speakers, a printer, etc. may also be included. The aforementioned devices are examples and others may be used. The electronic device 1400 may include one or more communication devices 1422 allowing communications with other electronic devices 1424. Examples of suitable communication devices 1422 include, but are not limited to, radio frequency (RF) transmitter, receiver, and/or transceiver circuitry; universal serial bus (USB), parallel, and/or serial ports.

The term computer-readable media may include computer storage media or devices. Computer storage media may include volatile and nonvolatile, removable and non-removable media implemented in any method or technology for storage of information, such as computer readable instructions, data structures, or program modules.

The memory 1404, the removable storage device 1414, and the non-removable storage device 1416 are all computer storage media examples (e.g., memory storage or storage device). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 1400. Any such computer storage media may be part of the electronic device 1400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 14 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality described herein, with respect to the capability of client to switch protocols may be operated via application-specific logic integrated with other components of the electronic device 1400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

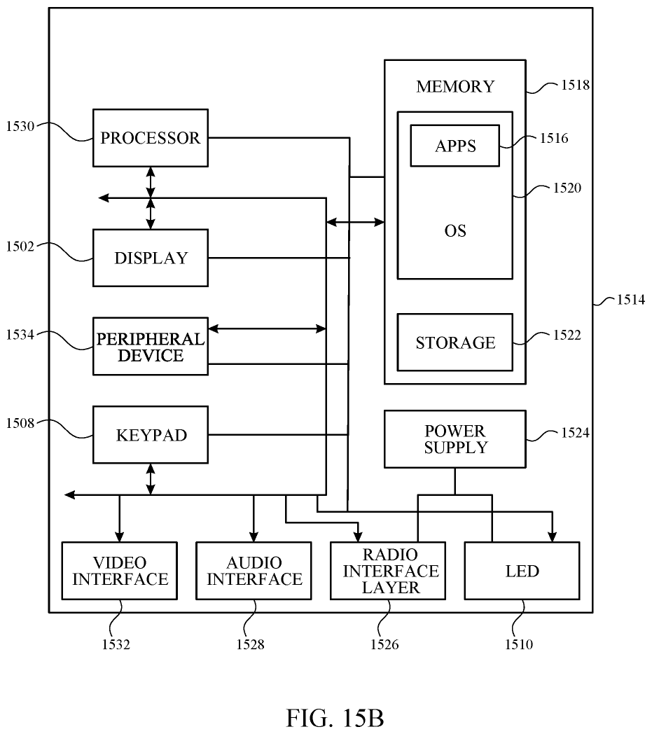

FIGS. 15A-15B illustrate a mobile electronic device 1500, for example, a mobile telephone, a smart phone, wearable computer (such as a smart watch), a tablet computer, a laptop computer, and the like, with which embodiments of the disclosure may be practiced. With reference to FIG. 15A, one aspect of a mobile electronic device 1500 for implementing the aspects described herein is illustrated.

In a basic configuration, the mobile electronic device 1500 is a handheld computer having both input elements and output elements. The mobile electronic device 1500 typically includes a display 1502 and one or more input buttons 1504 that allow the user to enter information into the mobile electronic device 1500. The display 1502 of the mobile electronic device 1500 may also function as an input device (e.g., a display that accepts touch and/or force input).

If included, an optional side input element 1506 allows further user input. The side input element 1506 may be a rotary switch, a button, or any other type of manual input element. In alternative aspects, mobile electronic device 1500 may incorporate more or less input elements. For example, the display 1502 may not be a touch screen in some embodiments. In yet another alternative embodiment, the mobile electronic device 1500 is a portable phone system, such as a cellular phone. The mobile electronic device 1500 may also include an optional keypad 1508. Optional keypad 1508 may be a physical keypad or a “soft” keypad generated on the touch screen display.

In various embodiments, the output elements include the display 1502 for showing a graphical user interface (GUI) of a client or developer portal, a visual indicator 1510 (e.g., a light emitting diode), and/or an audio transducer 1512 (e.g., a speaker). In some aspects, the mobile electronic device 1500 incorporates a vibration transducer for providing the user with tactile feedback. In yet another aspect, the mobile electronic device 1500 incorporates input and/or output ports, such as an audio input (e.g., a microphone jack), an audio output (e.g., a headphone jack), and a video output (e.g., a HDMI port) for sending signals to or receiving signals from an external device.

FIG. 15B is a block diagram illustrating the architecture of one aspect of a mobile electronic device 1500. That is, the mobile electronic device 1500 can incorporate a system (e.g., an architecture) 1514 to implement some aspects. In one embodiment, the system 1514 is implemented as a “smart phone” capable of running one or more applications (e.g., browser, e-mail, calendaring, contact managers, messaging clients, games, media clients/players, diagramming, and sharing applications and so on). In some aspects, the system 1514 is integrated as an electronic device, such as an integrated personal digital assistant (PDA) and wireless phone.

One or more application programs 1516 may be loaded into the memory 1518 and run on or in association with the operating system 1520. Examples of the application programs include a phone dialer program, an electronic communication program (e.g., electronic mail program, instant message program), a triggering application program, a word processing program, a spreadsheet program, an Internet browser program, and so forth.

The system 1514 also includes a non-volatile storage area 1522 within the memory 1518. The non-volatile storage area 1522 may be used to store persistent information that should not be lost when the system 1514 is powered down.

The application programs 1516 may use and store information in the non-volatile storage area 1522, such as email, attachments or other messages used by an email application, and the like. A synchronization application (not shown) also resides on the system 1514 and is programmed to interact with a corresponding synchronization application resident on a host computer to keep the information stored in the non-volatile storage area 1522 synchronized with corresponding information stored at the host computer.

The system 1514 has a power supply 1524, which may be implemented as one or more batteries. The power supply 1524 may further include an external power source, such as an AC adapter or a powered docking cradle that supplements or recharges the batteries.

The system 1514 may also include a radio interface layer 1526 that performs the function of transmitting and receiving radio frequency communications. The radio interface layer 1526 facilitates wireless connectivity between the system 1514 and the “outside world,” via a communications carrier or service provider. Transmissions to and from the radio interface layer 1526 are conducted under control of the operating system 1520. In other words, communications received by the radio interface layer 1526 may be disseminated to the application programs 1516 via the operating system 1520, and vice versa.

The visual indicator 1510 may be used to provide visual notifications, and/or an audio interface 1528 may be used for producing audible notifications via an audio transducer (e.g., audio transducer 1512 illustrated in FIG. 15A). In the illustrated embodiment, the visual indicator 1510 is a light emitting diode (LED) and the audio transducer 1512 may be a speaker. These devices may be directly coupled to the power supply 1524 so that when activated, they remain on for a duration dictated by the notification mechanism even though the processor 1530 and other components might shut down for conserving battery power. The LED may be programmed to remain on indefinitely until the user takes action to indicate the powered-on status of the device.

The audio interface 1528 is used to provide audible signals to and receive audible signals from the user (e.g., voice input such as described above). For example, in addition to being coupled to the audio transducer 1512, the audio interface 1528 may also be coupled to a microphone to receive audible input, such as to facilitate a telephone conversation.

The system 1514 may further include a video interface 1532 that enables an operation of peripheral device 1534 (e.g., on-board camera) to record still images, video stream, and the like.

A mobile electronic device 1500 implementing the system 1514 may have additional features or functionality. For example, the mobile electronic device 1500 may also include additional data storage devices (removable and/or non-removable) such as, magnetic disks, optical disks, or tape. Such additional storage is illustrated in FIG. 15B by the non-volatile storage area 1522.

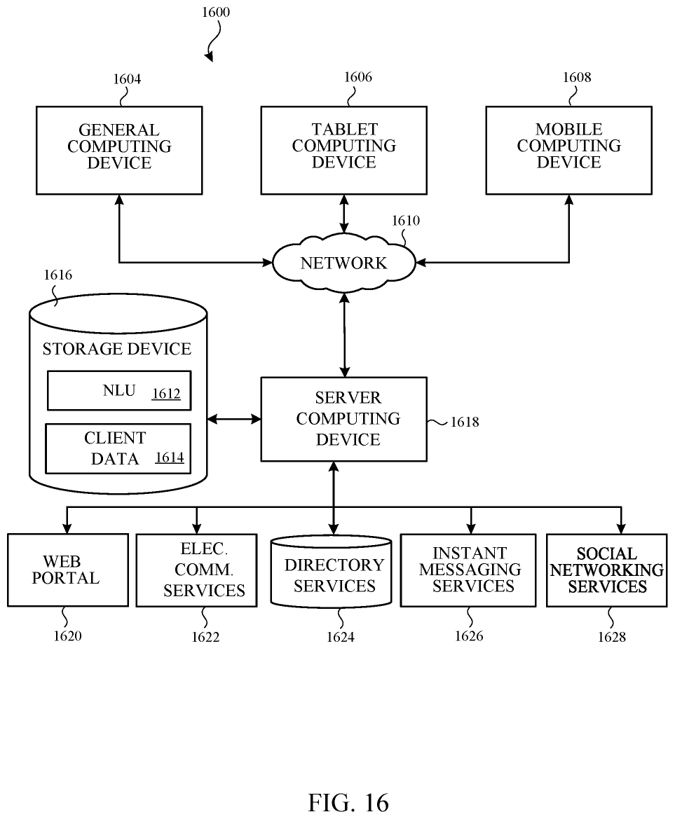

Data/information generated or captured by the mobile electronic device 1500 and stored via the system 1514 may be stored locally on the mobile electronic device 1500, as described above, or the data may be stored on any number of storage media that may be accessed by the device via the radio interface layer 1526 or via a wired connection between the mobile electronic device 1500 and a separate electronic device associated with the mobile electronic device 1500, for example, a server-computing device in a distributed computing network, such as the Internet (e.g., server computing device 1618 in FIG. 16). As should be appreciated such data/information may be accessed via the mobile electronic device 1500 via the radio interface layer 1526 or via a distributed computing network. Similarly, such data/information may be readily transferred between electronic devices for storage and use according to well-known data/information transfer and storage means, including electronic mail and collaborative data/information sharing systems.

As should be appreciated, FIG. 15A and FIG. 15B are described for purposes of illustrating the present methods and systems and is not intended to limit the disclosure to a particular sequence of steps or a particular combination of hardware or software components.

FIG. 16 illustrates a block diagram of a distributed system in which aspects of the disclosure may be practiced. The system 1600 includes a general computing device 1604 (e.g., a desktop computer), a tablet computing device 1606, and/or a mobile computing device 1608. The general computing device 1604, the tablet computing device 1606, and the mobile computing device 1608 can each include the components, or be connected to the components, that are shown associated with the electronic device 1400 in FIG. 14 or the mobile electronic device 1500 in FIGS. 15A-15B.

The general computing device 1604, the tablet computing device 1606, and the mobile computing device 1608 are each configured to access one or more networks (represented by network 1610) to interact with the NLU application 1612 stored in one or more storage devices (represented by storage device 1616) and executed on one or more server computing devices (represented by server computing device 1618). The storage device 1616 further stores a client data repository 1614 that is accessed by the NLU application 1612 (e.g., a triggering application in the NLU application 1612).

In some aspects, the server computing device 1618 can access and/or receive various types of services, communications, documents and information transmitted from other sources, such as a web portal 1620, an electronic communications services 1622, directory services 1624, instant messaging and/or text services 1626, and/or social networking services 1628. In some instances, these sources may provide robust reporting, analytics, data compilation and/or storage service, etc., whereas other services may provide search engines or other access to data and information, images, graphics, videos, document processing and the like.

As should be appreciated, FIG. 16 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, GUIs, and computer program products according to aspects of the disclosure. As discussed earlier, the operations noted in the blocks may occur out of the order as shown in any flowchart. For example, two blocks shown in succession may in fact be executed substantially concurrently or the blocks may sometimes be executed in the reverse order, depending upon the functionality/acts involved. Additionally, the functionality or elements shown in one GUI can be used in another GUI, and vice versa.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternative aspects falling within the spirit of the broader aspects of the general inventive concept embodied in this application that do not depart from the broader scope of the claimed disclosure.

1. A method, comprising:
receiving a natural language (NL) query;
based on a semantic similarity between the NL query and a predefined query that is associated with an assigned application, determining the NL query is to be processed by the assigned application;
causing the NL query to be transmitted to the assigned application to enable the assigned application to process the NL query;
receiving a response to the NL query; and
causing the response to be provided to an output device.

2. The method of claim 1, further comprising determining a similarity score for the predefined query by comparing the NL query to the predefined query, the similarity score representing the semantic similarity between the NL query and the predefined query.

3. The method of claim 2, further comprising transforming the NL query into one or more word embeddings that represent the NL query, wherein:
the predefined query is represented by one or more word embeddings; and
determining the similarity score for the predefined query by comparing the NL query to the predefined query comprises determining the similarity score for the predefined query by comparing the one or more word embeddings that represent the NL query to the one or more word embeddings that represent the predefined query.

4. The method of claim 2, wherein:
the assigned application is a first assigned application;
the predefined query is a first predefined query;
the similarity score is a first similarity score;
the assigned application is one of a plurality of assigned applications, the plurality of assigned applications including the first assigned application and a second assigned application;
the second assigned application is associated with a second predefined query; and
the method further comprises:
determining a second similarity score for the second predefined query by comparing the NL query to the second predefined query; and
determining the first similarity score is higher than the second similarity score.

5. The method of claim 1, further comprising normalizing the NL query prior to transmitting the NL query to the assigned application, the normalizing causing the NL query to be formatted in a format that is recognized by the assigned application.

6. The method of claim 1, wherein:
receiving the NL query comprises receiving a query request that includes the NL query and a user identifier that includes data that identifies a user submitting the NL query; and
the method further comprises determining, prior to transmitting the NL query to the assigned application, the user has permission to access the assigned application based on the user identifier.

7. The method of claim 1, wherein:
receiving the NL query comprises receiving a query request that includes the NL query and a client identifier that includes data that identifies a client; and
the method further comprises determining which assigned applications are to be considered for processing the NL query based on the client identifier.

8. The method of claim 1, wherein the predefined query is received via a graphical user interface and stored prior to determining the NL query is to be processed by the assigned application.

9. A system, comprising:
a processing device; and
a storage device operably connected to the processing device and storing instructions, that when executed by the processing device, cause operations comprising:
receiving a natural language (NL) query;
determining a first similarity score between the NL query and a first predefined query that is associated with a first assigned application;
determining a second similarity score between the NL query and a second predefined query associated with a second assigned application;
when the value of the first similarity score is higher than the value of the second similarity score:
transmitting the NL query to the first assigned application to enable the first assigned application to process the NL query;
receiving a first response to the NL query; and
providing the first response to the output device; and
when a value of the second similarity score is higher than a value of the first similarity score:
transmitting the NL query to the second assigned application to enable the second assigned application to process the NL query;
receiving a second response to the NL query; and
providing the second response to an output device.

10. The system of claim 9, wherein the storage device stores further instructions for:
transforming the NL query into one or more word embeddings that represent the NL query prior to determining the first similarity score; and
receiving one or more word embeddings that represent the first predefined query prior to determining the first similarity score.

11. The system of claim 10, wherein determining the first similarity score comprises:
comparing the one or more word embeddings that represent the NL query to the one or more word embeddings that represent the first predefined query; and
computing the first similarity score based on how similar the one or more word embeddings that represent the NL query are to the one or more word embeddings that represent the first predefined query.

12. The system of claim 9, wherein the storage device stores further instructions for:
transforming the NL query into one or more word embeddings that represent the NL query prior to determining the second similarity score;
receiving one or more word embeddings that represent the second predefined query prior to determining the second similarity score;
comparing the one or more word embeddings that represent the NL query to the one or more word embeddings that represent the second predefined query; and
computing the second similarity score based on how similar the one or more word embeddings that represent the NL query are to the one or more word embeddings that represent the second predefined query.

13. The system of claim 9, wherein the storage device stores further instructions for:
comparing the NL query to a data domain;
determining a third similarity score between the NL query and the data domain;
when a value of the third similarity score is higher than the values of the first and the second similarity scores, providing the NL query to a primary application to process and produce a third response to the NL query; and
causing the third response to be provided to the output device.

14. The system of claim 9, wherein determining the first similarity score between the NL query and the first predefined query comprises determining the first similarity score based on a semantic similarity between the NL query and the first predefined query and a constraint associated with the first predefined query.

15. The system of claim 9, wherein:
receiving the NL query comprises receiving a query request that includes the NL query and a user identifier that includes data that identifies a user submitting the NL query; and
the storage device stores further instructions for determining, prior to transmitting the NL query to the first assigned application or the second assigned application, the user has permission to access the first and the second assigned applications based on the user identifier.

16. The system of claim 15, wherein:
receiving the NL query comprises receiving a query request that includes the NL query and a client identifier that includes data that identifies a client; and
the storage device stores further instructions for determining which assigned applications are to be considered for processing the NL query based on the client identifier.

17. A method, comprising:
receiving, at a primary application, a natural language (NL) query;
determining a first similarity score between the NL query and a predefined query, wherein the predefined query is associated with an assigned application;
determining a second similarity score between the NL query and a data domain, wherein the data domain is associated with data that is accessible by the primary application;
determining a value of the first similarity score is higher than a value of the second similarity score;
based on determining the value of the first similarity score is higher, determining the NL query is to be processed by the assigned application;
causing the NL query to be transmitted to the assigned application to enable the assigned application to process the NL query;
receiving a response to the NL query; and
causing the response to be provided to an output device.

18. The method of claim 17, further comprising:
transforming the NL query into one or more word embeddings that represent the NL query prior to determining the first similarity score; and
receiving one or more word embeddings that represent the first predefined query prior to determining the first similarity score.

19. The method of claim 17, further comprising:
determining the value of the second similarity score is higher than the value of the first similarity score;
based on determining the value of the second similarity score is higher, determining the NL query is to be processed by the primary application;
receiving a response to the NL query; and
causing the response to be provided to the output device.

20. The method of claim 17, wherein determining the first similarity score between the NL query and the predefined query comprises determining the first similarity score based on a semantic similarity between the NL query and the first predefined query and a constraint associated with the first predefined query.
